(19) United States
(12) Patent Application Publication
(10) Pub. No.: US 2026/0206729 A1
(43) Pub. Date: Jul. 23, 2026

(54) Repositionable Ice Hole Fishing Net Device

(71) Applicant: Robert Monahan, Rochester, MN (US)

(72) Inventor: Robert Monahan, Rochester, MN (US)

(21) Appl. No.: 19/276,425

(22) Filed: Jul. 22, 2025

Related U.S. Application Data
(60) Provisional application No. 63/748,497, filed on Jan. 23, 2025.

(51) Int. Cl. A01K 77/00; A01K 97/01

(52) U.S. Cl. CPC A01K 77/005; A01K 77/00; A01K 97/01

(57) ABSTRACT

A repositionable ice hole fishing net device is provided. The device is comprised of a handle, at least one pivoting arm, and a curved net configured for use in ice fishing environments. The handle is ergonomically shaped and comprises non-slip grip areas and textured surfaces for secure handling in cold and wet conditions. At least one, but preferably two, pivoting arms are attached to the handle through pivot points that enable rotational articulation. These arms may be telescopic and include internal locking mechanisms allowing extension and secure positioning. The curved net is connected to the pivoting arms via additional pivot points, enabling the net to transition between vertical and horizontal orientations. During use, the device can be inserted into an ice fishing hole around a fish, wherein the net can be placed in a horizontal position and then used to lift the fish upwards from the ice hole.

### CROSS-REFERENCE TO RELATED APPLICATION

The present application claims priority to, and the benefit of, U.S. Provisional Application No. 63/748,497, which was filed on Jan. 23, 2025, and is incorporated herein by reference in its entirety.

### FIELD OF THE INVENTION

The present invention relates generally to the field of ice fishing. More specifically, the present invention relates to a repositionable ice hole fishing net device that prevents the loss of fish during retrieval from ice fishing holes. Accordingly, the present disclosure makes specific reference thereto. Nonetheless, it is to be appreciated that aspects of the present invention are also equally applicable to other like applications, devices, and methods of manufacture.

### BACKGROUND

Ice fishing presents unique challenges due to the nature of the environment and the techniques required to retrieve fish from beneath the ice surface. One common problem encountered during ice fishing is the risk of losing a hooked fish while attempting to lift it from the ice fishing hole. As the fish is drawn through the air, it may dislodge the hook, fall back into the water, and escape. This not only results in the loss of the fish but can also lead to frustration and reduced efficiency during fishing sessions. Additionally, ice slush often accumulates in the fishing hole over time, obstructing visibility and complicating the retrieval process. Fishermen are frequently required to manually remove this slush, which is both time-consuming and inconvenient. Traditional ice fishing tools do not adequately address the combined issues of fish loss during retrieval and slush removal. There is a need for a tool specifically designed to facilitate the secure extraction of fish from ice holes while also managing ice slush. These issues underline the necessity for a purpose-built solution to improve the overall experience and success rate of ice fishing.

Therefore, there exists a long-felt need in the art for a repositionable ice hole fishing net device that prevents the loss of fish during retrieval from ice fishing holes. There also exists a long-felt need in the art for a repositionable ice hole fishing net device that simultaneously enables efficient removal of ice slush from the fishing hole. Moreover, there exists a long-felt need in the art for a repositionable ice hole fishing net device that provides adjustable and secure positioning for various ice hole dimensions and fish sizes. In addition, there exists a repositionable ice hole fishing net device that can be used to initially remove slush after creating an ice hole.

The subject matter disclosed and claimed herein, in one embodiment thereof, comprises a repositionable ice hole fishing net device. The device is comprised of a handle, at least one pivoting arm, and a curved net configured for use in ice fishing environments. The handle is ergonomically shaped and comprises non-slip grip areas and textured surfaces for secure handling in cold and wet conditions. At least one, but preferably two, pivoting arms are attached to the handle through pivot points that enable rotational articulation. These arms may be telescopic and include internal locking mechanisms allowing extension and secure positioning. The arms may be comprised of integrated depth measurement systems with durable markings for accurate placement within ice holes. The curved net is connected to the pivoting arms via additional pivot points, enabling the net to transition between vertical and horizontal orientations. The net comprises a plurality of openings allowing water and slush to drain while retaining fish. During use, the device can be inserted into an ice fishing hole around a fish, wherein the net can be placed in a horizontal position and then used to lift the fish upwards from the ice hole.

In this manner, the repositionable ice hole fishing net device of the present invention accomplishes all the foregoing objectives and provides a means to securely retrieve fish from ice holes, thereby preventing loss during extraction. The curved net and adjustable pivoting arms enable the user to position the net beneath the fish, facilitating secure lifting while allowing slush and water to drain. The device additionally serves as an effective tool for removing accumulated ice slush, enhancing visibility and accessibility in the fishing hole. The ergonomic handle and telescopic arms ensure adaptability to various fishing conditions, supporting efficient and safe operation. Thus, the invention addresses the challenges of fish loss and slush buildup during ice fishing, offering a practical and versatile solution.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a repositionable ice hole fishing net device. The device is a fishing tool designed to prevent fish loss during retrieval from ice fishing holes. The device is comprised of a handle, at least one pivoting arm, and a curved net. The handle is shaped ergonomically and includes a non-slip grip area and grip texture to enhance control in cold, wet conditions. At least one, preferably two, pivoting arms are attached to the handle via pivot points, allowing rotational movement. The pivot points are comprised of mechanical assemblies that enable the curved net to transition from storage to deployment configuration by translating handle manipulation into angular movement of the arms. In one embodiment, each pivoting arm is telescopic and comprised of internal locking mechanisms that secure the arms at various lengths, allowing adaptation to different ice hole depths and fish sizes. Each arm may include an integrated depth measurement system, comprised of laser-etched markings, to allow depth monitoring during use.

The device is further comprised of a curved net configured to fit standard ice fishing holes. The net includes openings for water and slush drainage while retaining a fish. Each arm connects to the net via pivot points, enabling rotation between vertical and horizontal positions, allowing precise adjustment of the net's orientation during use. The net is comprised of materials selected for strength, durability, and resistance to low temperatures, such as HDPE, nylon, stainless steel wire, coated metal mesh, or composite polymers. The rotational capability of the net allows vertical insertion around a fish and repositioning beneath the fish during retrieval via manipulation of the arms through the handle. To maintain the net's orientation, the arms and/or pivot points may be locked using locking mechanisms located on or near the handle, preventing accidental repositioning. Additionally, the device functions as an ice scoop, with the net enabling the removal of slush and ice debris while allowing water to drain through the openings.

The invention is further comprised of a method of use, including providing the device, extending and locking the telescopic arms, inserting the net around a fish, rotating the net beneath the fish, locking the arms, retrieving the fish by lifting the handle, and optionally using the net to remove ice debris from the hole.

Accordingly, the repositionable ice hole fishing net device of the present invention is particularly advantageous as it provides a means to securely retrieve fish from ice holes, thereby preventing loss during extraction. The curved net and adjustable pivoting arms enable the user to position the net beneath the fish, facilitating secure lifting while allowing slush and water to drain. The device additionally serves as an effective tool for removing accumulated ice slush, enhancing visibility and accessibility in the fishing hole. The ergonomic handle and telescopic arms ensure adaptability to various fishing conditions, supporting efficient and safe operation. As a result, the invention addresses the challenges of fish loss and slush buildup during ice fishing, offering a practical and versatile solution.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a repositionable ice hole fishing net device of the present invention in a vertical position in accordance with the disclosed architecture;

FIG. 2 illustrates a perspective view of one potential embodiment of a repositionable ice hole fishing net device of the present invention in a horizontal position in accordance with the disclosed architecture;

FIG. 3 illustrates an enhanced perspective view of one potential embodiment of a repositionable ice hole fishing net device of the present invention in a horizontal position in accordance with the disclosed architecture; and

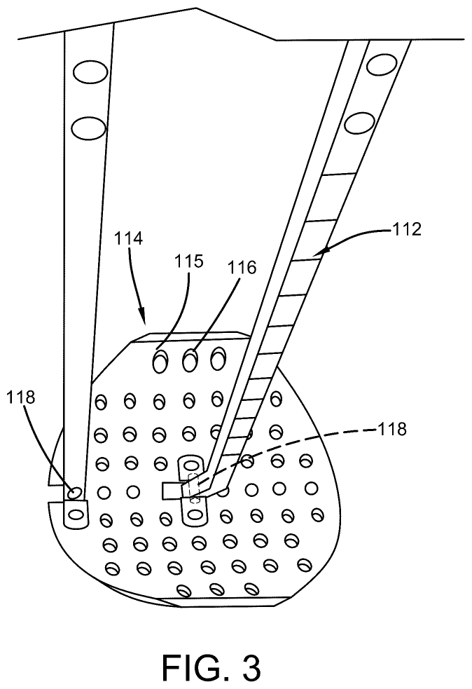

FIG. 4 illustrates a flowchart of a method of using one potential embodiment of a repositionable ice hole fishing net device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a repositionable ice hole fishing net device that prevents the loss of fish during retrieval from ice fishing holes. There also exists a long-felt need in the art for a repositionable ice hole fishing net device that simultaneously enables efficient removal of ice slush from the fishing hole. Moreover, there exists a long-felt need in the art for a repositionable ice hole fishing net device that provides adjustable and secure positioning for various ice hole dimensions and fish sizes. In addition, there exists a repositionable ice hole fishing net device that can be used to initially remove slush after creating an ice hole.

The present invention, in one exemplary embodiment, is comprised of a repositionable ice hole fishing net device. The device is a fishing tool designed to prevent fish loss during retrieval from ice fishing holes. The device is comprised of a handle, at least one pivoting arm, and a curved net. The handle is ergonomically shaped and includes a non-slip grip area and grip texture to enhance control in cold and wet conditions. At least one, preferably two, pivoting arms are attached to the handle via pivot points, allowing rotational movement. The pivot points are comprised of mechanical assemblies that enable the curved net to transition from storage to deployment configuration by translating handle manipulation into angular movement of the arms. In one embodiment, each pivoting arm is telescopic and comprised of internal locking mechanisms that secure the arms at various lengths, allowing adaptation to different ice hole depths and fish sizes. Each arm may include an integrated depth measurement system comprising laser-etched markings to allow depth monitoring during use.

The device is further comprised of a curved net configured to fit standard ice fishing holes. The net includes openings for water and slush drainage while retaining a fish. Each arm connects to the net via pivot points, enabling rotation between vertical and horizontal positions, allowing precise adjustment of the net's orientation during use. The net is comprised of materials selected for strength, durability, and resistance to low temperatures, including HDPE, nylon, stainless steel wire, coated metal mesh, or composite polymers. The rotational capability of the net allows vertical insertion around a fish and repositioning beneath the fish during retrieval through manipulation of the arms via the handle. To maintain the net's orientation, the arms and pivot points may be locked using locking mechanisms located on or near the handle, preventing accidental repositioning. Additionally, the device functions as an ice scoop, with the net enabling the removal of slush and ice debris while allowing water to drain through the openings.

The invention is further comprised of a method of use, including providing the device, extending and locking the telescopic arms, inserting the net around a fish, rotating the net beneath the fish, locking the arms, retrieving the fish by lifting the handle, and optionally using the net to remove ice debris from the hole.

As a result, the repositionable ice hole fishing net device provides a means to securely retrieve fish from ice holes, preventing loss during extraction. The curved net and adjustable pivoting arms enable positioning of the net beneath the fish, facilitating secure lifting while allowing slush and water to drain. The device also serves as a tool for removing accumulated ice slush, enhancing visibility and accessibility in the fishing hole. The ergonomic handle and telescopic arms ensure adaptability to various fishing conditions, supporting efficient and safe operation. The invention addresses the challenges of fish loss and slush buildup during ice fishing, offering a practical and versatile solution.

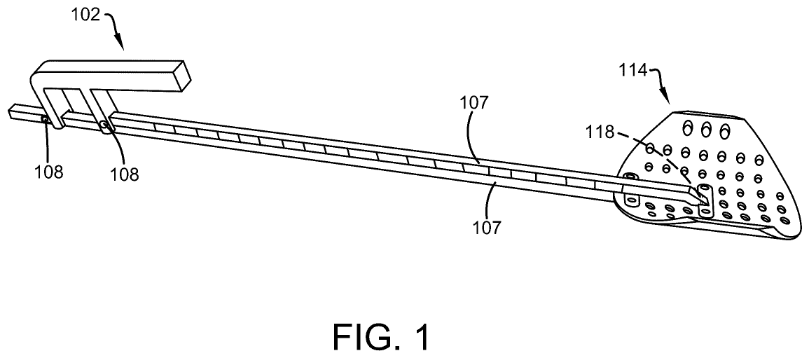

Referring initially to the drawings, FIG. 1 illustrates a perspective view of one potential embodiment of a repositionable ice hole fishing net device 100 of the present invention in a vertical position in accordance with the disclosed architecture. The device 100 is a specialized fishing tool designed to prevent the loss of fish during retrieval from ice fishing holes. The device 100 is comprised of a handle 102, at least one pivoting arm 107, and a curved net 114.

The handle 102 may be any ergonomic shape, such as, but not limited to, cylindrical, elliptical, or contoured geometries optimized for comfortable handling. The handle 102 may be comprised of a non-slip grip area 104, such as, but not limited to, rubberized coatings, textured polymers, or thermoplastic elastomers, which enhance control of the handle 102 in cold and wet conditions. Additionally, the handle 102 may be comprised of a grip texture 106, such as, but not limited to, cross-hatch patterns, knurling, or molded surface features, which provide additional friction to prevent slippage.

At least one, but preferably two, pivoting arms 107 are attached to the handle 102 via at least one (but preferably two) pivot point(s) 108. The arms 107 are preferably (but not limited to) made from a fiberglass material. The pivot points 108 are configured to allow rotational articulation of the pivoting arms 107 relative to the handle 102 and net 114. Each pivot point 108 may be comprised of mechanical assemblies, such as, but not limited to, hinge pins, rotational bearings, ball-and-socket joints, etc., which permit controlled angular displacement within a defined range of motion. The functional role of the pivot points 108 is to facilitate the rotation of the arms 107, enabling the curved net 114 to transition from a storage and insertion configuration to an operational deployment configuration. More specifically, when the handle 102 is manipulated by the user, the pivot points 108 translate rotational input into angular movement of the arms 107, positioning the net 114 within or beneath the ice hole.

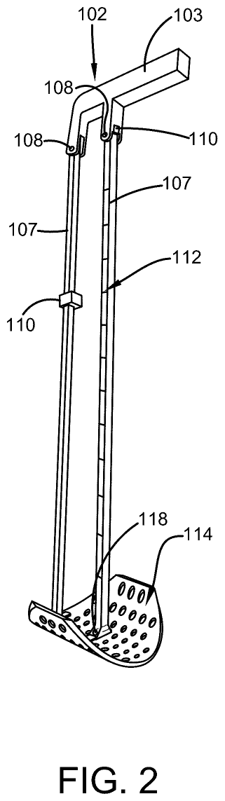

In one embodiment, each pivoting arm 107 may be telescopic and is comprised of internal locking mechanisms 110 (as seen in FIG. 2), which may include twist-lock collars, spring-loaded buttons, or ratchet-based systems. These locking mechanisms 110 enable the arms 107 to extend and lock at various lengths, providing adaptability to different ice hole depths and fish sizes.

Each arm 107 may be further comprised of an integrated depth measurement system 112, as seen in FIG. 1 and FIG. 2, to allow a user to note the depth of the device 100 within an ice fishing hole. The depth measurement system 112 may be in the form of laser-etched, embossed, molded, painted, etc., markings in units such as, but not limited to, inches, feet, centimeters, meters, etc., designed to resist environmental wear and remain legible in freezing and wet conditions.

The device 100 is further comprised of a curved net 114, configured to fit standard ice fishing hole diameters. The net 114 has a plurality of openings 116 that permit water and slush to drain through the net 114 while securely retaining a fish on the net 114. Each arm 107 connects to the net 114 via at least one pivot point 118 such as, but not limited to, hinge pins, rotational bearings, or ball-and-socket joints etc. enabling the net 114 to rotate between a vertical position, wherein a top surface 115 of the net 114 is generally parallel with the arms 107 as seen in FIG. 1, and a horizontal position as seen in FIG. 2, wherein the top surface 115 of the net 114 is generally parallel with a top surface 103 of the handle 102. The pivot points 118 are located at the junction between the distal ends of the pivoting arms 107 and the curved net 114. The pivot points 118 enable the net 114 to rotate along an axis perpendicular to the longitudinal axis of the arms 107. Each pivot point 118 may be comprised of similar mechanical elements as pivot points 108, including hinge pins, rotational bearings, or ball-and-socket joints, designed to permit precise adjustment of the net 114 from a vertical storage orientation to a horizontal deployment orientation.

The net 114 may be comprised of various materials selected for strength, durability, and resistance to low temperatures and moisture exposure, such as, but not limited to, high-density polyethylene (HDPE), nylon, stainless steel wire, coated metal mesh, composite polymers, etc., or any combination thereof. The selection of material for the net 114 may be based on desired weight, flexibility, ease of cleaning, and long-term exposure to freezing environments typically encountered during ice fishing applications.

This rotational capability allows the net 114 to be inserted and positioned within an ice fishing hole around a fish vertically and then repositioned beneath the fish horizontally during retrieval via manipulating the arms 107 via the handle 102.

To maintain the desired orientation of the net 114 in one embodiment, the arms 107 and/or pivot points 108 may be locked in place using locking mechanisms 120, such as, but not limited to, cam locks, threaded collars, or latch systems, located on or near the handle 102. The locking mechanisms 120 may be engaged after the desired orientation is achieved, preventing accidental repositioning of the net 114 due to handling or environmental conditions.

Beyond fish retrieval, the device 100 also functions as an ice scoop. More specifically, the net 114 enables efficient removal of slush and ice debris from the hole while draining excess water through the openings 116.

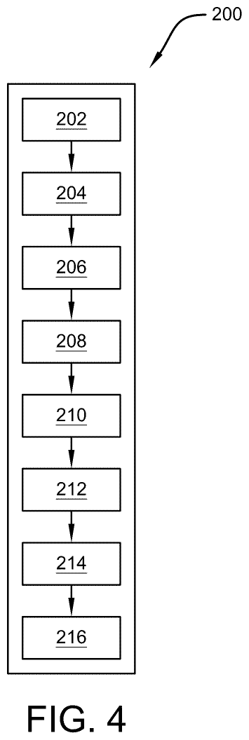

The present invention is also comprised of a method of using 200 the device 100, as seen in FIG. 4. First, a device 100 is provided, comprised of a handle 102, at least one pivoting arm 107, and a curved net 114 [Step 202]. Next, in an embodiment wherein the arms 107 are telescopic, the arms 107 may be telescopically extended to a desired length and locked into place using internal locking mechanisms 110 [Step 204]. Then, the curved net 114 is inserted into an ice fishing hole around a fish in an orientation wherein a top surface 114 of the net 114 is generally parallel with the arms 107 [Step 206]. Then, the net 114 is rotated from a vertical position to a horizontal position (wherein the tops surface 115 is generally parallel with a top surface 103 of a handle 102) via manipulate the handle 102 such that the arms 107 reposition the net 114 via the pivot points 108, 118, positioning the net 114 for fish retrieval beneath the fish within the ice hole [Step 208]. In one embodiment, the pivoting arms 107 are secured using locking mechanisms 120 to maintain the orientation of the net 114 during use [Step 210]. Then, the handle 102 is pulled upwards from the ice hole such that the net 114 lifts the fish from the ice hole, allowing water and slush to drain through the openings 116 [Step 214]. The device 100 may then optionally be used to remove slush and ice debris from the ice hole by utilizing the curved net 114 as an ice scoop while allowing excess water to drain through the openings 116 [Step 216].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “repositionable ice hole fishing net device” and “device” are interchangeable and refer to the repositionable ice hole fishing net device 100 of the present invention.

Notwithstanding the foregoing, the repositionable ice hole fishing net device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the repositionable ice hole fishing net device 100 as shown in the FIGS. are for illustrative purposes only, and that many other sizes and shapes of the repositionable ice hole fishing net device 100 are well within the scope of the present disclosure. Although the dimensions of the repositionable ice hole fishing net device 100 are important design parameters for user convenience, the repositionable ice hole fishing net device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A repositionable ice hole fishing net device comprising:
a handle;
a pivoting arm connected to the handle via a first pivot point; and
a curved net connected to the pivoting arm via a second pivot point;
wherein the second pivot point is configured to allow rotation of the curved net along an axis perpendicular to a longitudinal axis of the pivoting arm; and
further wherein the curved net is rotatable via the second pivot point between a vertical position, wherein a top surface of the curved net is generally parallel with the pivoting arm, and a horizontal position, wherein the top surface of the curved net is generally parallel with a top surface of the handle.

2. The repositionable ice hole fishing net device of claim 1, wherein the curved net is comprised of an opening.

3. The repositionable ice hole fishing net device of claim 1, wherein the handle is comprised of a non-slip grip area.

4. The repositionable ice hole fishing net device of claim 1, wherein the handle is comprised of a texture.

5. The repositionable ice hole fishing net device of claim 1, wherein the pivoting arm is comprised of a depth measurement system.

6. The repositionable ice hole fishing net device of claim 1 further comprised of a locking mechanism.

7. The repositionable ice hole fishing net device of claim 6, wherein the locking mechanism inhibits movement of the pivoting arm.

8. The repositionable ice hole fishing net device of claim 1, wherein the first pivot point and the second pivot point is comprised of a hinge pin.

9. The repositionable ice hole fishing net device of claim 1, wherein the first pivot point and the second pivot point is comprised of a rotational bearing.

10. A repositionable ice hole fishing net device comprising:
a handle;
a telescopic pivoting arm connected to the handle via a first pivot point; and
a curved net connected to the pivoting arm via a second pivot point;
wherein the second pivot point is configured to allow rotation of the curved net along an axis perpendicular to a longitudinal axis of the pivoting arm; and
further wherein the curved net is rotatable via the second pivot point between a vertical position, wherein a top surface of the curved net is generally parallel with the pivoting arm, and a horizontal position, wherein the top surface of the curved net is generally parallel with a top surface of the handle.

11. The repositionable ice hole fishing net device of claim 10, wherein the telescopic pivoting arm is comprised of a locking mechanism.

12. The repositionable ice hole fishing net device of claim 10, wherein the curved net is comprised of an opening.

13. The repositionable ice hole fishing net device of claim 10, wherein the handle is comprised of a non-slip grip area.

14. The repositionable ice hole fishing net device of claim 10, wherein the handle is comprised of a texture.

15. The repositionable ice hole fishing net device of claim 10, wherein the pivoting arm is comprised of a depth measurement system.

16. The repositionable ice hole fishing net device of claim 10 further comprised of a locking mechanism.

17. The repositionable ice hole fishing net device of claim 16, wherein the locking mechanism inhibits movement of the pivoting arm.

18. The repositionable ice hole fishing net device of claim 10, wherein the first pivot point and the second pivot point is comprised of a hinge pin.

19. The repositionable ice hole fishing net device of claim 10, wherein the first pivot point and the second pivot point is comprised of a rotational bearing.

20. A method of using a repositionable ice hole fishing net device, the method comprising the following steps:
providing a repositionable ice hole fishing net device comprised of comprising a handle, a pivoting arm, and a curved net;
inserting the curved net into an ice fishing hole around a fish in an orientation wherein a top surface of the curved net is generally parallel with the pivoting arm;
rotating the curved net from a vertical position to a horizontal position, wherein the top surface of the curved net is generally parallel with a top surface of the handle, by manipulating the handle such that the pivoting arm repositions the curved net via a first pivot point and a second pivot point, thereby positioning the curved net beneath the fish within the ice fishing hole;
securing the pivoting arm using a locking mechanism to maintain the orientation of the curved net; and
pulling the handle upwards from the ice fishing hole such that the curved net lifts the fish from the ice fishing hole, allowing water and slush to drain through a plurality of openings in the curved net.
